(19) United States
(12) Patent Application Publication
(10) Pub. No.: US 2008/0205307 A1
(43) Pub. Date: Aug. 28, 2008

(54) Transmitting Signals Via at Least Two Hannels Simultaneously

(75) Inventors: Bertrand Jacques Leonard Vandewiele, Eindhoven (NL); Manel Collados, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,781

(22) PCT Filed: Jun. 8, 2005
(86) PCT No.: PCT/IB05/51879

§ 371 Date: Nov. 29, 2006

(30) Foreign Application Priority Data
Jun. 10, 2004 (EP) 04102640.2

(51) Int. Cl. H04L 5/00; H04L 27/26

(52) U.S. Cl. 370/297

(57) ABSTRACT

A transmitter (10) of an apparatus (1) for transmitting signals via at least two channels simultaneously is provided with a data processing system (30), a first serial branch (20) comprising a first inverse Fourier transformer (40,42), a second serial branch (21) comprising a second inverse Fourier transformer (41), a digital-to-analog converting system (50-53) and a radio system (60-63), the first and second serial branches being coupled in parallel. This transmitter (10) is backward compatible to a high extent. The radio system (60-63) either comprises a radio unit (60,61,62) per serial branch (20,21) or is located after the combiner (15-17) to save hardware. In the latter case, a component converter (90) or an upsampler/phaseshifter (100) is required in the first serial branch (20). The digital-to-analog converting system (50-53) either comprises a converters (50,51,52) per serial branch (20,21) or is located after a combiner (15-17) to save hardware. In the latter case, an upsampler (101) is required in the second serial branch (21).

The invention relates to an apparatus comprising a transmitter for transmitting signals via at least two channels simultaneously, and also relates to a device, to a transmitter, to a method, to a processor program product, to a further apparatus, to a further device, to a further transmitter, to a further method and to a further processor program product.

Examples of such an apparatus and of such a further apparatus are wireless local area network cards, and examples of such a device and of such a further device are personal computers and other terminals.

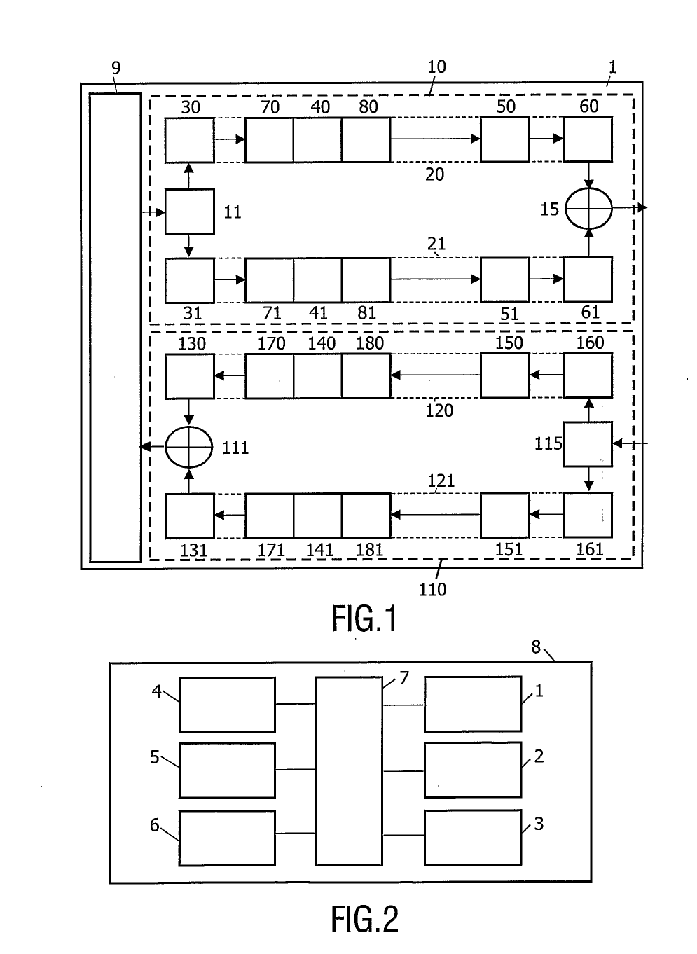

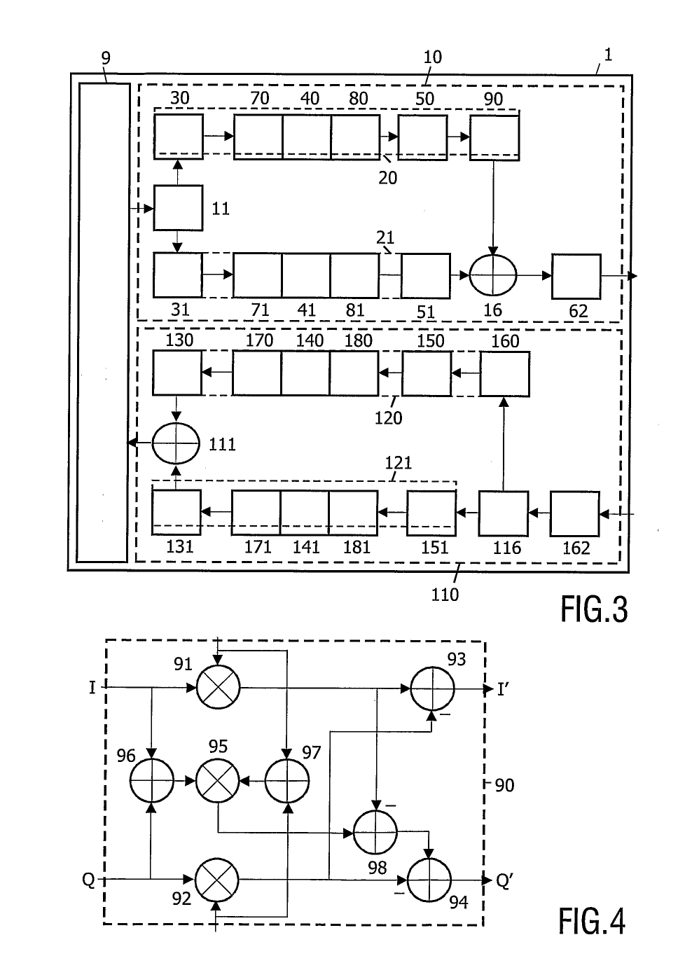

A prior art apparatus is known from US 2002/0003773 A1, which discloses an orthogonal frequency division multiplexing apparatus. As shown in its FIG. 3, a first, second, third information stream is encoded via a first, second, third channel encoder and frequency converted via a first, second, third frequency converter. The three encoded and converted streams are multiplexed by a multiplexer and then pass an inverse fast Fourier transformer, a guard interval adder, a modulator and a frequency converter. This way, as shown in its FIG. 2, the three streams can be transmitted via three channels simultaneously.

The known apparatus is disadvantageous, inter alia, owing to the fact that it is backward compatible to a relatively low extent: sometimes, in case a receiver can only receive one channel at a time, a transmitter can only transmit via one channel at a time. But the inverse fast Fourier transformer, the guard interval adder, the modulator and the frequency converter are specifically designed to handle the multiplexed result of the three streams and to transmit this multiplexed result of the three streams via the three channels simultaneously.

It is an object of the invention, inter alia, to provide an apparatus which is backward compatible to a relatively high extent.

Furthers objects of the invention are, inter alia, to provide a device, a transmitter, a method and a processor program product, which are backward compatible to a relatively high extent.

The apparatus according to the invention comprising a transmitter for transmitting signals via at least two channels simultaneously is defined by the transmitter comprising:

a data processing system;

a first serial branch comprising a first inverse Fourier transformer;

a second serial branch comprising a second inverse Fourier transformer;

a digital-to-analog converting system; and

a radio system;

the first and second serial branches being coupled in parallel.

By introducing the data processing system, the serial branches coupled in parallel to each other, the digital-to-analog converting system and the radio system, the apparatus according to the invention is backward compatible to a relatively high extent. The parallel construction of the inverse Fourier transformers such as for example inverse fast Fourier transformers allows each inverse Fourier transformer to be responsible for its own channel. In case of only one channel needing to be used, only one of the serial branches needs to be used, and the other serial branch can be de-activated. To optimize this one serial branch for the one channel, either small adaptations of even no adaptations at all are required.

Of course, three or more serial branches each comprising its own inverse Fourier transformer are not to be excluded.

An embodiment of the apparatus according to the invention is defined by the transmitter further comprising:

a combiner for combining first and second branch output signals into a combined signal.

By combining the branch output signals into the combined signal, only one antenna is needed for transmitting the signals to be transmitted. Such a combiner for example comprises an adder.

An embodiment of the apparatus according to the invention is defined by the digital-to-analog converting system comprising a first digital-to-analog converter forming part of the first serial branch and a second digital-to-analog converter forming part of the second serial branch, the radio system comprising a first radio unit forming part of the first serial branch for generating the first branch output signal and a second radio unit forming part of the second serial branch for generating the second branch output signal. This way, each branch comprises its own digital-to-analog converter and its own radio unit, which allows each digital-to-analog converter and each radio unit to be responsible for its own channel.

An embodiment of the apparatus according to the invention is defined by the radio system comprising an input for receiving the combined signal, the first and second inverse Fourier transformers using the same number of symbols. This way, one of the two radio units of the previous embodiment is avoided and hardware is saved.

An embodiment of the apparatus according to the invention is defined by the digital-to-analog converting system comprising a first digital-to-analog converter forming part of the first serial branch and a second digital-to-analog converter forming part of the second serial branch for generating the second branch output signal, the transmitter further comprising:

a component converter forming part of the first serial branch for generating the first branch output signal, which component converter comprises an input coupled to an output of the first digital-to-analog converter.

In the orthogonal frequency division multiplexing situation, each digital-to-analog converter comprises two digital-to-analog converting units, one for converting an in phase component, and one other for converting a quadrature component. The component converter performs a complex multiplication of the in phase and the quadrature components with a complex carrier exp(j2πf), with f for example being equal to 20 MHz. In that case, the inphase and quadrature components entering each digital-to-analog converter are sampled at 20 MHz, the inphase and quadrature components leaving each digital-to-analog converter each have a bandwidth of 10 MHz, and the inphase and quadrature components leaving the component converter each have a bandwidth of 30 MHz. The RF signal leaving the radio system will then have a bandwidth of 40 MHz.

An embodiment of the apparatus according to the invention is defined by the digital-to-analog converting system comprising a first digital-to-analog converter forming part of the first serial branch for generating the first branch output signal and a second digital-to-analog converter forming part of the second serial branch for generating the second branch output signal, the transmitter further comprising:

an upsampler/phaseshifter forming part of the first serial branch, which upsampler/phaseshifter comprises an input coupled to an output of the first inverse Fourier transformer and an output coupled to an input of the first digital-to-analog converter.

This way, the analog component converter of the previous embodiment has been shifted from an analog area to a digital area and is replaced by the digital upsampler/phaseshifter. This digital upsampler/phaseshifter can be implemented through digital technology, and for example samples up three times and performs a phase shift corresponding with a complex multiplication of the inphase and the quadrature components with a complex carrier exp(j2πn/3). The first digital-to-analog converter will then need to be three times faster than the second digital-to-analog converter (60 MHz versus 20 MHz).

An embodiment of the apparatus according to the invention is defined by the radio system comprising an input coupled to an output of the digital-to-analog converting system, the digital-to-analog converting system comprising an input for receiving the combined signal, the first inverse Fourier transformer for generating the first branch output signal using a larger number of symbols than the second inverse Fourier transformer, the transmitter further comprising:

an upsampler forming part of the second serial branch for generating the second branch output signal, which upsampler comprises an input coupled to an output of the second inverse Fourier transformer.

This way, one of the two digital-to-analog converters of the previous embodiment is avoided and hardware is saved. The first inverse Fourier transformer for example uses 128 symbols, and the second inverse Fourier transformer then uses 64 symbols. In that case, the inphase and quadrature components leaving the first serial branch are sampled at 40 MHz (bandwidth 20 MHz), the inphase and quadrature components entering the upsampler are sampled at 20 MHz (bandwidth 10 MHz), and the inphase and quadrature components leaving the digital-to-analog converting system each have a bandwidth of 20 MHz. The digital-to-analog converting system will then need to be twice as fast as the second digital-to-analog converter of the previous embodiment (40 MHz versus 20 MHz).

An embodiment of the apparatus according to the invention is defined by the transmitter further comprising:

a splitter for splitting a splitter signal into first and second branch input signals.

Such a splitter for example comprises a demultiplexer.

An embodiment of the apparatus according to the invention is defined by the data processing system comprising a first data processing unit forming part of the first serial branch for receiving the first branch input signal and a second data processing unit forming part of the second serial branch for receiving the second branch input signal. This way, each branch comprises its own data processing unit, which allows each data processing unit to be responsible for its own channel.

An embodiment of the apparatus according to the invention is defined by the data processing system comprising an output for generating the splitter signal. This way, one of the data processing units of the previous embodiment is avoided and hardware is saved. A superior coding gain is achieved when using a common encoder. Of course, the data processing system will receive data at a double rate and will need to be two times faster compared to the data processing units.

An embodiment of the apparatus according to the invention is defined by each serial branch comprising a first inserter coupled to an input of the inverse Fourier transformer and a second inserter coupled to an output of the inverse Fourier transformer. The first inserter for example groups symbols into blocks of 48 symbols and inserts pilot carriers and null carriers to get 64 symbols per block. The second inserter for example inserts a number of last samples of a block at the beginning of that block, and is also known as guard interval adder.

Of course, the inverse Fourier transformers, the inserters, the data processing system/units, the component converter, the upsampler/phaseshifter, the upsampler, the digital-to-analog converting system, the digital-to-analog converters and the radio system/units may be made adjustable, for example to adjust frequencies and bandwidths. Further, the upsampler/phaseshifter and the upsampler may each be copied from their own serial branch into the other serial branch, possibly in adjustable form.

The device according to the invention is defined by comprising an apparatus comprising a transmitter for transmitting signals via at least two channels simultaneously, which transmitter comprises:

a data processing system;

a first serial branch comprising a first inverse Fourier transformer;

a second serial branch comprising a second inverse Fourier transformer;

a digital-to-analog converting system; and

a radio system;

the first and second serial branches being coupled in parallel.

The transmitter according to the invention for transmitting signals via at least two channels simultaneously is defined by comprising:

a data processing system;

a first serial branch comprising a first inverse Fourier transformer;

a second serial branch comprising a second inverse Fourier transformer;

a digital-to-analog converting system; and

a radio system;

the first and second serial branches being coupled in parallel.

The method according to the invention for transmitting signals via at least two channels simultaneously is defined by comprising the steps of:

data processing;

first inverse Fourier transforming via a first serial branch;

second inverse Fourier transforming via a second serial branch;

digital-to-analog converting; and

radio converting;

the first and second serial branches being in parallel.

The processor program product according to the invention for transmitting signals via at least two channels simultaneously is defined by comprising the functions of:

data processing;

first inverse Fourier transforming via a first serial branch;

second inverse Fourier transforming via a second serial branch;

digital-to-analog converting; and

radio converting;

the first and second serial branches being in parallel.

Embodiments of the device according to the invention and of the transmitter according to the invention and of the method according to the invention and of the processor program product according to the invention correspond with the embodiments of the apparatus according to the invention.

The invention is based upon an insight, inter alia, that one serial branch for transmitting a multiplexed result of three streams via three channels simultaneously results in an apparatus being backward compatible to a relatively low extent, and is based upon a basic idea, inter alia, that the parallel use of serial branches results in an apparatus being backward compatible to a relatively high extent.

The invention solves the problem, inter alia, to provide an apparatus which is backward compatible to a relatively high extent, and is advantageous, inter alia, in that this apparatus can be implemented in many different ways, each way having its own advantages. The apparatus according to the invention comprising at least two serial branches in parallel can be made backward compatible easily, by making one of the serial branches (the second one) equal to a prior art branch. Then, prior art receivers can still communicate with the transmitter according to the invention, but via one channel only. Finally, a corresponding receiver according to the invention will comprise a number of blocks corresponding with the blocks of the transmitter according to the invention but having a reversed functionality.

It is a yet further object of the invention, inter alia, to provide a further apparatus which is relatively efficient.

Furthers objects of the invention are, inter alia, to provide a further device, a further transmitter, a further method and a further processor program product, which are relatively efficient.

The further apparatus according to the invention comprises a further transmitter for transmitting signals via at least two channels simultaneously, which further transmitter comprises a serial branch of:

a data processing system;

a first inserter for grouping symbols into blocks of symbols and for inserting pilot carriers and null carriers;

an inverse Fourier transformer;

a second inserter for inserting a number of last samples of a block at the beginning of that block twice;

a digital-to-analog converting system having a bandwidth equal to or larger than a sum of the bandwidths of the channels; and

a radio system having a bandwidth equal to or larger than a sum of the bandwidths of the channels.

This further apparatus according to the invention is most efficient in view of hardware, but is backward compatible to a relatively low extent.

An embodiment of the further apparatus according to the invention is defined by the null carriers comprising first null carriers at the edges of the channels and second null carriers at non-edges of the channels, at least some of the second null carriers being filled with data. This way, the capacity of the further transmitter according to the invention is increased.

An embodiment of the further apparatus according to the invention is defined by the inverse Fourier transformer using 128 symbols, a block of symbols comprising 48+48+x data carriers, 0>x>12. The capacity can then be increased from 96 to at most 108 data carriers, which is more than 10% capacity increase.

The further device according to the invention is defined by comprising a further apparatus comprising a further transmitter for transmitting signals via at least two channels simultaneously, which further transmitter comprises a serial branch of:

a data processing system;

a first inserter for grouping symbols into blocks of symbols and for inserting pilot carriers and null carriers;

an inverse Fourier transformer;

a second inserter for inserting a number of last samples of a block at the beginning of that block twice;

a digital-to-analog converting system having a bandwidth equal to or larger than a sum of the bandwidths of the channels; and

a radio system having a bandwidth equal to or larger than a sum of the bandwidths of the channels.

The further transmitter according to the invention for transmitting signals via at least two channels simultaneously is defined by comprising a serial branch of:

a data processing system;

a first inserter for grouping symbols into blocks of symbols and for inserting pilot carriers and null carriers;

an inverse Fourier transformer;

a second inserter for inserting a number of last samples of a block at the beginning of that block twice;

a digital-to-analog converting system having a bandwidth equal to or larger than a sum of the bandwidths of the channels; and

a radio system having a bandwidth equal to or larger than a sum of the bandwidths of the channels.

The further method according to the invention for transmitting signals via at least two channels simultaneously is defined by comprising the steps of:

data processing;

grouping symbols into blocks of symbols and inserting pilot carriers and null carriers;

inverse Fourier transforming;

for inserting a number of last samples of a block at the beginning of that block twice;

digital-to-analog converting via a bandwidth equal to or larger than a sum of the bandwidths of the channels; and

radio converting via a bandwidth equal to or larger than a sum of the bandwidths of the channels.

The further processor program product according to the invention for transmitting signals via at least two channels simultaneously is defined by comprising the functions of:

data processing;

grouping symbols into blocks of symbols and inserting pilot carriers and null carriers;

inverse Fourier transforming;

for inserting a number of last samples of a block at the beginning of that block twice;

digital-to-analog converting via a bandwidth equal to or larger than a sum of the bandwidths of the channels; and

radio converting via a bandwidth equal to or larger than a sum of the bandwidths of the channels.

These and other aspects of the invention will be apparent from and elucidated with reference to the embodiments(s) described hereinafter.

In the drawings:

FIG. 1 shows diagrammatically an embodiment of an apparatus according to the invention comprising a transmitter according to the invention;

FIG. 2 shows diagrammatically a device according to the invention comprising an apparatus according to the invention;

FIG. 3 shows diagrammatically a further embodiment of an apparatus according to the invention comprising a transmitter according to the invention;

FIG. 4 shows a component converter for the transmitter according to the invention shown in FIG. 3;

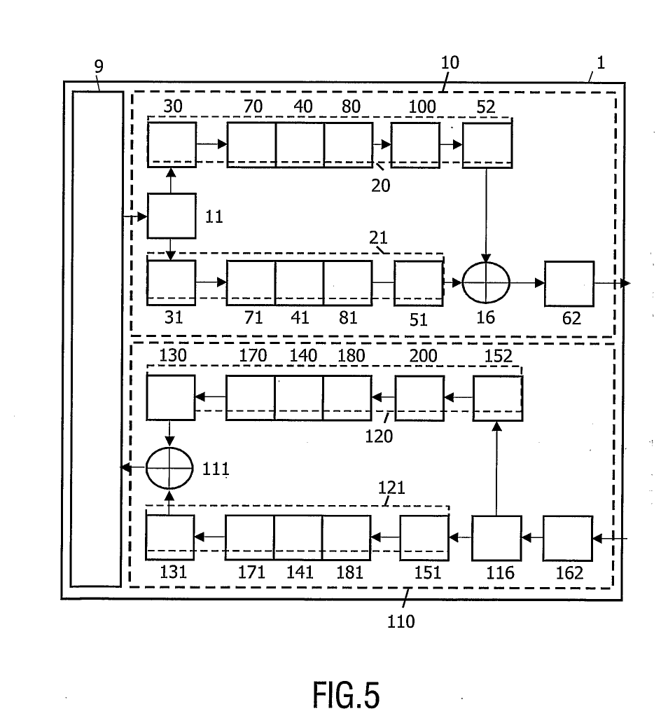

FIG. 5 shows diagrammatically a yet further embodiment of an apparatus according to the invention comprising a transmitter according to the invention;

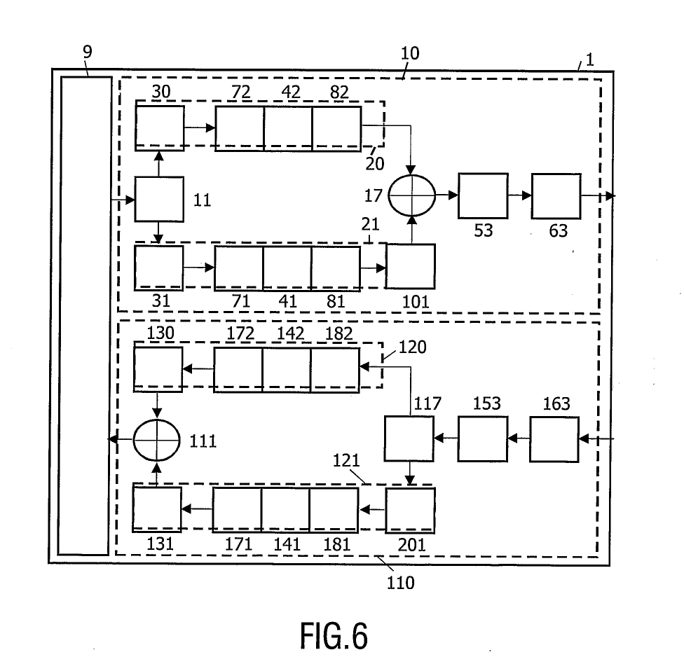

FIG. 6 shows diagrammatically an other embodiment of an apparatus according to the invention comprising a transmitter according to the invention;

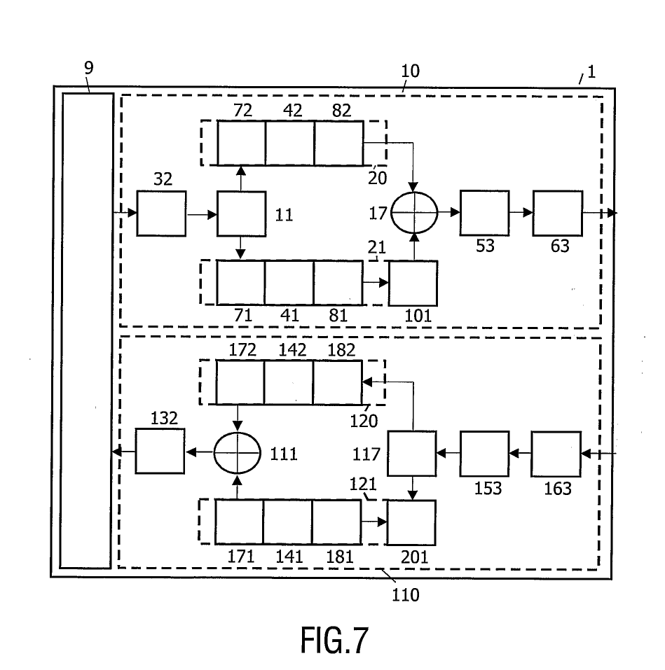

FIG. 7 shows diagrammatically a further other embodiment of an apparatus according to the invention comprising a transmitter according to the invention;

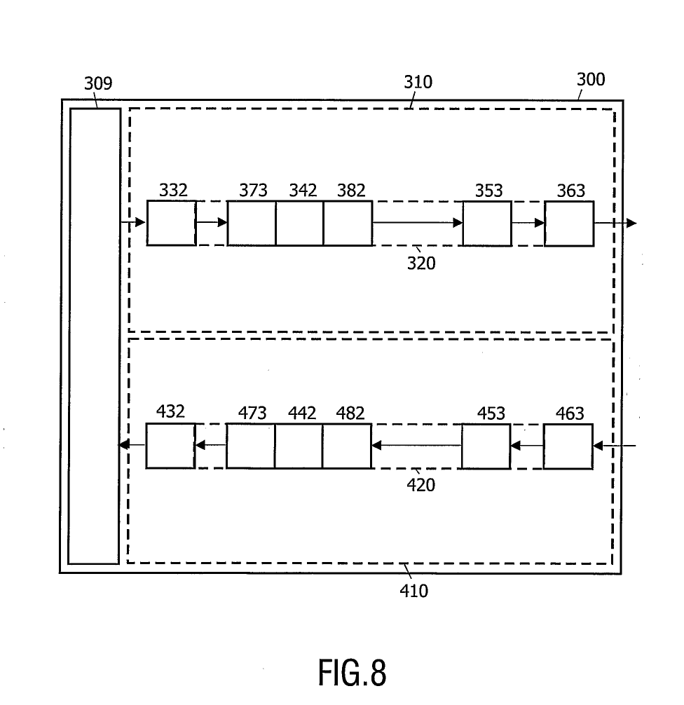

FIG. 8 shows diagrammatically an embodiment of a further apparatus according to the invention comprising a further transmitter according to the invention; and

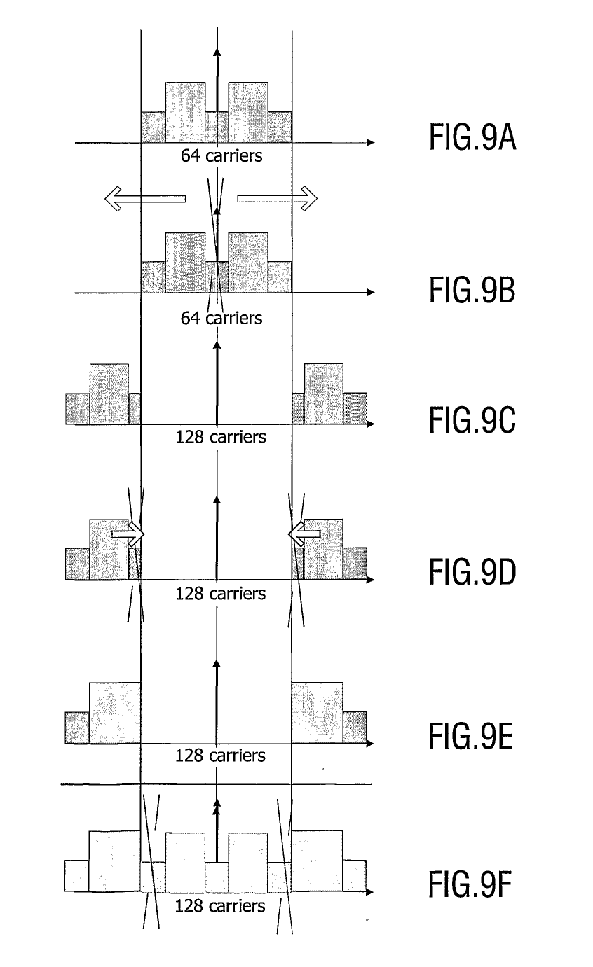

FIG. 9 shows a functionality of first inverters for the transmitters according to the invention shown in FIGS. 1, 3, 5, 6, 7 and 8.

The embodiment of an apparatus 1 according to the invention as shown in FIG. 1 (independent channel binding architecture) such as for example a wireless local area network card comprises a transmitter 10 according to the invention and a corresponding receiver 110 both coupled to a processor system 9. The transmitter 10 comprises a splitter 11 comprising an input for receiving a splitter signal from the processor system 9 and comprising first and second outputs coupled to first and second serial branches 20,21 for supplying first and second branch input signals.

The first (second) serial branch 20 (21) comprises a first (second) data processing unit 30 (31) for receiving the first (second) branch input signal. An output of the first (second) data processing unit 30 (31) is coupled to an input of a first inserter 70 (71). An output of the first inserter 70 (71) is coupled to an input of a first (second) inverse (fast) Fourier transformer 40 (41). An output of the first (second) inverse (fast) Fourier transformer 40 (41) is coupled to an input of a second inserter 80 (81). An output of the second inserter 80 (81) is coupled to an input of a first (second) digital-to-analog converter 50 (51). An output of the first (second) digital-to-analog converter 50 (5 1) is coupled to an input of a first (second) radio unit 60 (61). An output of the first (second) radio unit 60 (61) is coupled to a first (second) input of a combiner 15. An output of the combiner 15 is coupled to an antenna not shown (possibly via radio circuitry not shown) for transmitting signals via at least two channels simultaneously.

The first digital-to-analog converter 50 forming part of the first serial branch 20 and the second digital-to-analog converter 51 forming part of the second serial branch 21 together form a digital-to-analog converting system 50,51. The first radio unit 60 forming part of the first serial branch 20 for generating a first branch output signal and the second radio unit 61 forming part of the second serial branch 21 for generating a second branch output signal together form a radio system 60,61. The first data processing unit 30 forming part of the first serial branch 20 for receiving the first branch input signal and the second data processing unit 31 forming part of the second serial branch 21 for receiving the second branch input signal together form a data processing system 30,31.

The technology of the transmitter 10 is for example based on 5 GHz wireless orthogonal frequency division multiplexing. The splitter 11 for example comprises a demultiplexer. The first (second) data processing unit 30 (31) for example comprises a serial circuit of an encoder, a puncturer, an interleaver and a mapper. The first inserter 70 (71) for example groups complex symbols into blocks of 48 symbols, and inserts pilot and null carriers. The second inserter 80 (81) for example inserts a number of last samples of a block of symbols at the beginning of that block, and is also known as a guard interval adder. The inphase and quadrature components coming from the second inserter 80 (81) are for example sampled at 20 MHz. The first (second) digital-to-analog converter 50 (51) performs a digital-to-analog conversion and generates inphase and quadrature components each having a 10 MHz bandwidth. In the orthogonal frequency division multiplexing situation, each digital-to-analog converter 50 (51) comprises two digital-to-analog converting units, one for converting the inphase component, and one other for converting the quadrature component. The first (second) radio unit 60 (61) for example frequency translates the inphase and quadrature components to 5 GHz, whereby the first radio unit 60, compared to the second radio unit 61, will introduce an additional frequency shift of 20 MHz. The combiner 15 combines (adds) the branch output signals.

The corresponding receiver 110 comprises a splitter 115 comprising an input coupled to an (or the) antenna not shown and comprising first and second outputs coupled to first and second serial branches 120,121 for supplying first and second branch input signals.

The first (second) serial branch 120 (121) comprises a first (second) inverse radio unit 160 (161) for receiving the first (second) branch input signal. An output of the first (second) radio unit 160 (161) is coupled to an input of a first (second) analog-to-digital converter 150 (151). An output of the first (second) analog-to-digital converter 150 (151) is coupled to an input of an inverse second inserter 180 (181). An output of the inverse second inserter 180 (181) is coupled to an input of a first (second) (fast) Fourier transformer 140 (141). An output of the first (second) (fast) Fourier transformer 140 (141) is coupled to an input of an inverse first inserter 170 (171). An output of the inverse first inserter 170 (171) is coupled to an input of an inverse first (second) data processing unit 130 (131). An output of the inverse first (second) data processing unit 130 (131) is coupled to a first (second) input of a combiner 111. An output of the combiner 111 is coupled to the processor system 9.

The functionality of the receiver parts of receiver 110 is the inverse of the functionality of the transmitter parts of the transmitter 10.

The device 8 according to the invention as shown in FIG. 2 such as for example a personal computer or an other terminal comprises a processor 7 coupled to the apparatus 1, to a modem 2, to a man-machine-interface 3, to a video card 4, to a memory 5 and to an interface 6.

The further embodiment of an apparatus 1 according to the invention as shown in FIG. 3 (independent channel binding architecture) comprises a transmitter 10 according to the invention and a corresponding receiver 110 both coupled to a processor system 9. This further embodiment corresponds with the embodiment shown in FIG. 1, apart from the following. Instead of the radio system 60,61 comprising two radio units 60,61, now the radio system 62 comprises only one radio unit 62, and hardware is saved. This radio unit 62 is located after a combiner 16 for receiving a combined signal from the combiner 16. This combiner 16 no longer combines the branch output signals at 5 GHz, but operates in baseband. To make this possible, a component converter 90 has been introduced in the first serial branch 20. This component converter 90 generates the first branch output signal and receives the inphase (I) and quadrature (Q) components from the first digital-to-analog converter 50. These I and Q components each have a bandwidth of 10 MHZ. The I′ and Q′ components leaving the component converter 90 each have a bandwidth of 30 MHz. The component converter 90 is shown in greater detail in FIG. 4.

The corresponding receiver 110 corresponds with the receiver 110 shown in FIG. 1, apart from amendments corresponding with the amendments made for the transmitter 10 in FIG. 3. The functionality of the receiver parts of receiver 110 shown in FIG. 3 is the inverse of the functionality of the transmitter parts of the transmitter 10 shown in FIG. 3.

The component converter 90 as shown in FIG. 4 for the transmitter 10 according to the invention shown in FIG. 3 comprises three multipliers 91,92,95 and five adders 93,94,96,97,98. Multiplier 91 receives the I component and a cos(2π20MHz) signal, its output is coupled to a first (adding) input of adder 93 and to a first (subtracting) input of adder 98. Multiplier 92 receives the Q component and a sin(2π20MHz) signal, its output is coupled to a second (subtracting) input of adder 93 and to a first (subtracting) input of adder 94. Adder 96 receives the I and Q component, its output is coupled to a first input of multiplier 95. Adder 97 receives the cos(2π20MHz) signal and the sin(2π20MHz) signal, its output is coupled to a second input of multiplier 95. An output of multiplier 95 is coupled to a second (adding) input of adder 98, its output is coupled to a second (adding) input of adder 94. Adders 93 and 94 generate the I′ and Q′ component.

The yet further embodiment of an apparatus 1 according to the invention as shown in FIG. 5 (independent channel binding architecture) comprises a transmitter 10 according to the invention and a corresponding receiver 110 both coupled to a processor system 9. This yet further embodiment corresponds with the further embodiment shown in FIG. 3, apart from the following. The combination of the digital-to-analog converter 50 and the component converter 90 in FIG. 3 has been replaced by a combination of an upsampler/phaseshifter 100 and a digital-to-analog converter 52. So, the component converter 90 in FIG. 3 operates in an analog area, where the upsampler/phaseshifter 100 operates in a digital area. Such an upsampler/phaseshifter 100 for example comprises an upsampler (interpolator) for upsampling the I and Q component coming from the second inverter 80 by a factor three, and a phaseshifter comprising a multiplier for multiplying the upsampled I and Q components by exp(j2πn/3). The I and Q components leaving the phaseshifter are sampled at 60 MHz (bandwidth 30 MHz), and as a result, the digital-to-analog converter 52 must be three times faster than the digital-to-analog converters 50,51 in FIG. 1,3. The I and Q components leaving this digital-to-analog converter 52 each have a bandwidth of 30 MHz.

The corresponding receiver 110 corresponds with the receiver 110 shown in FIG. 3, apart from amendments corresponding with the amendments made for the transmitter 10 in FIG. 5. The functionality of the receiver parts of receiver 110 shown in FIG. 5 is the inverse of the functionality of the transmitter parts of the transmitter 10 shown in FIG. 5.

The other embodiment of an apparatus 1 according to the invention as shown in FIG. 6 (independent channel binding architecture) comprises a transmitter 10 according to the invention and a corresponding receiver 110 both coupled to a processor system 9. This other embodiment corresponds with the yet further embodiment shown in FIG. 5, apart from the following. The digital-to-analog converting system 50-52 comprising two digital-to-analog converters 50-52 in FIG. 5 has been replaced by a digital-to-analog converting system 53 comprising only one digital-to-analog converter 53, which receives the combined signal from a combiner 17 and is therefore located after the combiner 17. This combiner 17 receives the first and second branch output signals. To make this possible, in the first serial branch 20, the first inserter 70 has been replaced by a first inserter 72 farther discussed in greater detail at the hand of FIG. 9, the first inverse (fast) Fourier transformer 40 has been replaced by a first inverse (fast) Fourier) transformer 42 which uses 128 symbols, contrary to the inverse (fast) Fourier transformers 40,41 which use 64 symbols. Further, in the first serial branch 20, the second inserter 80 has been replaced by a second inserter 82, which inserts a number of last samples of a block at the beginning of that block twice. The I and Q components leaving the second inserter 82 are now sampled at 40 MHz. In the second serial branch 21, an upsampler 101 (interpolator) has been added for upsampling the I and Q components coming from the second inserter 81 by a factor two. The digital-to-analog converter 53 operates at double speed compared to the digital-to-analog converters 50,51. The I and Q components leaving this digital-to-analog converter 53 each have a bandwidth of 20 MHz. The radio unit 63 behaves like the radio unit 51 in case of the first serial branch being inactive, otherwise the radio unit 63 must shift the carrier frequency by 10 MHz. The radio unit 63 requires a bandwidth of 40 MHz.

The corresponding receiver 110 corresponds with the receiver 110 shown in FIG. 5, apart from amendments corresponding with the amendments made for the transmitter 10 in FIG. 6. The functionality of the receiver parts of receiver 110 shown in FIG. 6 is the inverse of the functionality of the transmitter parts of the transmitter 10 shown in FIG. 6.

The further other embodiment of an apparatus 1 according to the invention as shown in FIG. 7 (common code channel binding architecture) comprises a transmitter 10 according to the invention and a corresponding receiver 110 both coupled to a processor system 9. This further other embodiment corresponds with the other embodiment shown in FIG. 6, apart from the following. The data processing system 30,31 comprising two data processing units 30,31 has been shifted to the input of the splitter 11. The data processing system 32 now only comprises one data processing unit 32 for generating the splitter signal. The data processing unit 32 corresponds with the data processing units 30,31, apart from the fact that the data processing unit 32 receives an input signal at a double rate and is twice as fast.

The corresponding receiver 110 corresponds with the receiver 110 shown in FIG. 6, apart from amendments corresponding with the amendments made for the transmitter 10 in FIG. 7. The functionality of the receiver parts of receiver 110 shown in FIG. 7 is the inverse of the functionality of the transmitter parts of the transmitter 10 shown in FIG. 7.

The embodiment of a further apparatus 300 according to the invention as shown in FIG. 8 (full custom channel binding architecture) such as for example a wireless local area network card comprises a further transmitter 310 according to the invention and a corresponding further receiver 410 both coupled to a processor system 309. The further transmitter 310 comprises a serial branch 320 for receiving a branch input signal from the processor system 309 and for generating a branch output signal destined for an antenna not shown. The further apparatus 300 according to the invention forms for example part of a further device according to the invention, which further device according to the invention corresponds with the device according to the invention as shown in FIG. 2.

The serial branch 320 comprises a data processing unit 322 for receiving the branch input signal. This data processing unit 332 corresponds with the data processing unit 32 discussed above. An output of the data processing unit 332 is coupled to an input of a first inserter 373. This first inserter 373 is further discussed in greater detail at the hand of FIG. 9. An output of the first inserter 373 is coupled to an input of an inverse (fast) Fourier transformer 342. This inverse (fast) Fourier transformer 342 corresponds with the inverse (fast) Fourier transformer 42 discussed above. An output of the inverse (fast) Fourier transformer 342 is coupled to an input of a second inserter 382. This second inserter 382 corresponds with the second inserter 82 discussed above. An output of the second inserter 382 is coupled to an input of a digital-to-analog converter 353. This digital-to-analog converter 353 corresponds with the digital-to-analog converter 53 discussed above. An output of the digital-to-analog converter 353 is coupled to an input of a radio unit 363. This radio unit 363 corresponds with the radio unit 63 discussed above. An output of the radio unit 363 is coupled to an antenna not shown for transmitting signals via at least two channels simultaneously.

The corresponding further receiver 410 comprises a serial branch 420 for receiving a branch input signal for an (the) antenna not shown and for generating a branch output signal destined for the processor system 309.

The serial branch 420 comprises an inverse radio unit 463 for receiving the branch input signal. An output of the radio unit 463 is coupled to an input of an analog-to-digital converter 453. An output of the analog-to-digital converter 453 is coupled to an input of an inverse second inserter 482. An output of the inverse second inserter 482 is coupled to an input of a (fast) Fourier transformer 442. An output of the (fast) Fourier transformer 442 is coupled to an input of an inverse first inserter 473. An output of the inverse first inserter 473 is coupled to an input of an inverse data processing unit 432. An output of the inverse data processing unit 432 is coupled to the processor system 309.

The functionality of the receiver parts of the further receiver 410 is the inverse of the functionality of the transmitter parts of the further transmitter 310.

The functionality of first inverters 70,72,373 as shown in FIG. 9A-9F for the transmitters 10,300,310 according to the invention shown in FIGS. 1, 3, 5, 6, 7 and 8 discloses in FIG. 9A a functionality of the first inserter 70. The first inserter 70 groups complex symbols into blocks of 48 symbols, and inserts pilot and null carriers. In FIG. 9A, 6 null carriers are present for pulse shaping purposes, followed by 24 data carriers, 4 pilot carriers, another 24 data carriers and another 6 null carriers for pulse shaping purposes. In FIG. 9B the carriers are separated into a left part and a right part, and in FIG. 9C, the 6 null carriers, 24 data carriers and 2 pilot carriers at the left side are shifted to the left, and the 6 null carriers, 24 data carriers and 2 pilot carriers at the right side are shifted to the right, to go from 64 to 128 carriers and allowing an inverse (fast) Fourier transformation using 128 symbols. FIG. 9C represents implementations for the first inserter 72, and allow the results of the combination of the first inserter 72, the first inverse Fourier transformer 42 and the second inserter 82 to be combined (added) via the combiner 17 to the results of the combination of the first inserter 71, the second inverse Fourier transformer 41, the second inserter 81 and the upsampler 101. In FIG. 9D and 9E, the 2 pilot carriers at each side are also filled with data. In FIG. 9F, a combined (added) result is shown, whereby some of the null carriers may be filled in with data to further increase the efficiency of the transmitter 10,300. FIG. 9F represents implementations for the first inserter 373. So, of all null carriers comprising first null carriers at the edges of the channels and second null carriers at non-edges of the channels, at least some of the second null carriers can be filled with data. Then a block of symbols comprises 48+48+x data carriers, 0>x>12.

As will be clear, the embodiments shown in FIGS. 1, 3 and 5 are backward compatible, because one of the serial branches (the second one) is equal to a prior art branch. Then, prior art receivers can still communicate with the transmitter according to the invention, but via one channel only. The embodiments shown in FIGS. 6 and 7 can be made backward compatible easily by making the upsampler 101 adjustable: for being backward compatible, it should be adjusted in such a way that its upsample factor is made equal to one.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. Apparatus (1) comprising a transmitter (10) for transmitting signals via at least two channels simultaneously, which transmitter (10) comprises:
a data processing system (30-32);
a first serial branch (20) comprising a first inverse Fourier transformer (40,42);
a second serial branch (21) comprising a second inverse Fourier transformer (41);
a digital-to-analog converting system (50-53); and
a radio system (60-63);
the first and second serial branches (20,21) being coupled in parallel.

2. Apparatus (1) as defined in claim 1, the transmitter (10) further comprising:
a combiner (15-17) for combining first and second branch output signals into a combined signal.

3. Apparatus (1) as defined in claim 2, the digital-to-analog converting system (50,51) comprising a first digital-to-analog converter (50) forming part of the first serial branch (20) and a second digital-to-analog converter (51) forming part of the second serial branch (21), the radio system (60,61) comprising a first radio unit (60) forming part of the first serial branch (20) for generating the first branch output signal and a second radio unit (61) forming part of the second serial branch (21) for generating the second branch output signal.

4. Apparatus (1) as defined in claim 2, the radio system (62) comprising an input for receiving the combined signal, the first and second inverse Fourier transformers (40,41) using the same number of symbols.

5. Apparatus (1) as defined in claim 4, the digital-to-analog converting system (50,51) comprising a first digital-to-analog converter (50) forming part of the first serial branch (20) and a second digital-to-analog converter (51) forming part of the second serial branch (21) for generating the second branch output signal, the transmitter (10) further comprising
a component converter (90) forming part of the first serial branch (20) for generating the first branch output signal, which component converter (90) comprises an input coupled to an output of the first digital-to-analog converter (50).

6. Apparatus (1) as defined in claim 4, the digital-to-analog converting system (51,52) comprising a first digital-to-analog converter (52) forming part of the first serial branch (20) for generating the first branch output signal and a second digital-to-analog converter (51) forming part of the second serial branch for generating the second branch output signal, the transmitter (10) further comprising:
an upsampler/phaseshifter (100) forming part of the first serial branch (20), which upsampler/phaseshifter (100) comprises an input coupled to an output of the first inverse Fourier transformer (40) and an output coupled to an input of the first digital-to-analog converter (52).

7. Apparatus (1) as defined in claim 2, the radio system (63) comprising an input coupled to an output of the digital-to-analog converting system (53), the digital-to-analog converting system (53) comprising an input for receiving the combined signal, the first inverse Fourier transformer (42) for generating the first branch output signal using a larger number of symbols than the second inverse Fourier transformer (41), the transmitter (10) further comprising:
an upsampler (101) forming part of the second serial branch (21) for generating the second branch output signal, which upsampler (101) comprises an input coupled to an output of the second inverse Fourier transformer (41).

8. Apparatus (1) as defined in claim 1, the transmitter (10) further comprising:
a splitter (11) for splitting a splitter signal into first and second branch input signals.

9. Apparatus (1) as defined in claim 8, the data processing system (30,31) comprising a first data processing unit (30) forming part of the first serial branch (20) for receiving the first branch input signal and a second data processing unit (31) forming part of the second serial branch (21) for receiving the second branch input signal.

10. Apparatus (1) as defined in claim 8, the data processing system (32) comprising an output for generating the splitter signal.

11. Apparatus (1) as defined in claim 1, each serial branch (20,21) comprising a first inserter (70-72) coupled to an input of the inverse Fourier transformer (40-42) and a second inserter (80-82) coupled to an output of the inverse Fourier transformer (40-42).

12. Device (8) which comprises an apparatus (1) comprising a transmitter (10) for transmitting signals via at least two channels simultaneously, which transmitter (10) comprises:
a data processing system (30-32);
a first serial branch (20) comprising a first inverse Fourier transformer (40,42);
a second serial branch (21) comprising a second inverse Fourier transformer (41);
a digital-to-analog converting system (50-53); and
a radio system (60-63);
the first and second serial branches (20,21) being coupled in parallel.

13. Transmitter (10) for transmitting signals via at least two channels simultaneously, which transmitter (10) comprises:
a data processing system (30-32);
a first serial branch (20) comprising a first inverse Fourier transformer (40,42);
a second serial branch (21) comprising a second inverse Fourier transformer (41);
a digital-to-analog converting system (50-53); and
a radio system (60-63);
the first and second serial branches (20,21) being coupled in parallel.

14. Method for transmitting signals via at least two channels simultaneously, which method comprises the steps of:
data processing;
first inverse Fourier transforming via a first serial branch (10);
second inverse Fourier transforming via a second serial branch (20);
digital-to-analog converting; and
radio converting;
the first and second serial branches (10,20) being in parallel.

15. Processor program product for transmitting signals via at least two channels simultaneously, which processor program product comprises the functions of:
data processing;
first inverse Fourier transforming via a first serial branch (10);
second inverse Fourier transforming via a second serial branch (20);
digital-to-analog converting; and
radio converting;
the first and second serial branches (10,20) being in parallel.

16. Further apparatus (300) comprising a further transmitter (310) for transmitting signals via at least two channels simultaneously, which further transmitter (310) comprises a serial branch (320) of:
a data processing system (332);
a first inserter (373) for grouping symbols into blocks of symbols and for inserting pilot carriers and null carriers;
an inverse Fourier transformer (342);
a second inserter (382) for inserting a number of last samples of a block at the beginning of that block twice;
a digital-to-analog converting system (353) having a bandwidth equal to or larger than a sum of the bandwidths of the channels; and
a radio system (363) having a bandwidth equal to or larger than a sum of the bandwidths of the channels.

17. Further apparatus (300) as defined in claim 16, the null carriers comprising first null carriers at the edges of the channels and second null carriers at non-edges of the channels, at least some of the second null carriers being filled with data.

18. Further apparatus (300) as defined in claim 17, the inverse Fourier transformer (342) using 128 symbols, a block of symbols comprising 48+48+x data carriers, 0>x>12.

19. Further device (800) which comprises a further apparatus (300) comprising a further transmitter (310) for transmitting signals via at least two channels simultaneously, which further transmitter (310) comprises a serial branch (320) of:
a data processing system (332);
a first inserter (373) for grouping symbols into blocks of symbols and for inserting pilot carriers and null carriers;
an inverse Fourier transformer (342);
a second inserter (382) for inserting a number of last samples of a block at the beginning of that block twice;
a digital-to-analog converting system (353) having a bandwidth equal to or larger than a sum of the bandwidths of the channels; and
a radio system (363) having a bandwidth equal to or larger than a sum of the bandwidths of the channels.

20. Further transmitter (310) for transmitting signals via at least two channels simultaneously, which further transmitter (310) comprises a serial branch (320) of:
a data processing system (332);
a first inserter (373) for grouping symbols into blocks of symbols and for inserting pilot carriers and null carriers;
an inverse Fourier transformer (342);
a second inserter (382) for inserting a number of last samples of a block at the beginning of that block twice;
a digital-to-analog converting system (353) having a bandwidth equal to or larger than a sum of the bandwidths of the channels; and
a radio system (363) having a bandwidth equal to or larger than a sum of the bandwidths of the channels.

21. Further method for transmitting signals via at least two channels simultaneously, which further method comprises the steps of:
data processing;
grouping symbols into blocks of symbols and inserting pilot carriers and null carriers;
inverse Fourier transforming;
for inserting a number of last samples of a block at the beginning of that block twice;
digital-to-analog converting via a bandwidth equal to or larger than a sum of the bandwidths of the channels; and
radio converting via a bandwidth equal to or larger than a sum of the bandwidths of the channels.

22. Further processor program product for transmitting signals via at least two channels simultaneously, which further processor program product comprises the functions of:
data processing;
grouping symbols into blocks of symbols and inserting pilot carriers and null carriers;
inverse Fourier transforming;
for inserting a number of last samples of a block at the beginning of that block twice;
digital-to-analog converting via a bandwidth equal to or larger than a sum of the bandwidths of the channels; and
radio converting via a bandwidth equal to or larger than a sum of the bandwidths of the channels.
